(19) United States
(12) Patent Application Publication
(10) Pub. No.: US 2007/0230665 A1
(43) Pub. Date: Oct. 4, 2007

(54) NOISE REDUCTION IN BRAKES & CLUTCHES

(75) Inventor: Rajagopal Narayanasamy, Bangalore (IN)

Correspondence Address: PETER VOGEL;GE HEALTHCARE, 3000 N. GRANDVIEW BLVD., SN-477, WAUKESHA, WI, 53188, US

(73) Assignee: General Electric Company, Schenectady, NY (US)

(21) Appl. No.: 11/278,350

(22) Filed: Mar. 31, 2006

(51) Int. Cl. H05G 1/02

(52) U.S. Cl. 378/196

(57) ABSTRACT

Noise control systems and methods for brakes and clutches are disclosed, in which voltage profiles comprise at least one or two step profiles and at least one ramp profile. The voltage profiles are selectively applied to at least one of a stationary member or rotary member of the brake or clutch in order to decrease noise during operation thereof. Such systems and methods can be adapted for use in medical imaging equipment, particularly to decrease the noise of brakes and clutches commonly associated therewith.

### FIELD OF INVENTION

In general, the inventive arrangements relate to brakes and clutches, and more specifically, to systems and methods for reducing or eliminating audible noise in brakes and clutches during brake and clutch operations, such as, by way of illustrative, exemplary, representative, and non-limiting example, the types of brake and clutch operations provided in driving or controlling medical imaging equipment and the like.

### BACKGROUND OF INVENTION

For illustrative, exemplary, representative, and non-limiting purposes, a preferred embodiment of the inventive arrangements will be described in terms of medical imaging equipment. However, the inventive arrangements are not limited in this regard.

For example, common medical imaging equipment includes radiology, vascular imaging, fluoroscopy, mammography, X-ray, computed tomography (CT), nuclear medicine (NM), positron emission tomography (PET), magnetic resonance imaging (MRI), and ultrasound apparatuses, and the like. Such equipment commonly includes an electromechanical device for driving or controlling movement of a patient positioner, such as a patient table, gantry comprising a pivot arm or c-arm, or the like. Such devices may also include an electromechanical brake or electromechanical clutch, which permit equipment operators to control movement of such patient positioners.

For example, and referring now to FIG. 1, a common electromechanical brake or brake system 10 comprises at least one stationary member 20 coupled to at least one rotary member 30. Commonly, the stationary member 20 is further coupled to an electromagnet 22, which is coupled to a brake coil 24, which can be selectively energized or de-energized by a power supply 26. The electromagnet 22 applies an electromagnetic force B to the stationary member 20. Likewise, the rotary member 30 is releasably coupled to a base plate 32, which is coupled to a brake spring 34. The brake spring 34 applies a spring force F to the rotary member 30.

Commonly, when the brakes 10 are applied, the power supply 26 de-energizes the brake coil 24, which allows the brake coil 24 to magnetize the electromagnet 22. In this condition, the magnetic force B overcomes or is allowed to overcome the spring force F, causing the stationary member 20 and rotary member 30 to draw or be drawn together. This allows the stationary member 20 and rotary member 30 to be brought together, thereby preventing the rotary member 30 from moving freely or rotating relative to the stationary member 20. Not surprisingly, a significant amount of noise is generated as the stationary member 20 and rotary member 30 draw or are drawn together and strike. Likewise, when the brakes 10 are released or not being applied, the power supply 26 energizes the brake coil 24, which allows the brake coil 24 to demagnetize the electromagnet 22. In this condition, the spring force F overcomes or is allowed to overcome the electromagnetic force B, causing the rotary member 30 and base plate 32 to draw or be drawn together. This allows the stationary member 20 and rotary member 30 to separate or move apart, thereby allowing the rotary member 30 to move freely or rotate relative to the stationary member 20. Not surprisingly, a significant amount of noise is generated as the rotary member 30 and base plate 32 draw or are drawn together and strike.

As described, a voltage, such as a DC supply voltage from the power supply 26, preferably energizes or de-energizes the brake coil 24. Also as described, since each of the stationary member 20, rotary member 30, and base plate 32 are made of traditionally metal or metallic materials, the metal-to-metal contact generates the described noise, which can cause a disturbance or inconvenience to applicable parties, including, for example, equipment operators utilizing the medical imaging equipment or a patient being examined. And in an emergency brake operation, noise levels can climb even disturbingly higher.

One traditional solution to decreasing unwanted brake noise in conventional brake or brake systems 10 includes placing a ring damper around a brake drum, such that relative motion and controlled slippage are permitted between the ring damper and the brake drum whenever the ring damper vibrates during brake apply or release operations. However, this solution requires adding additional hardware to the brake or brake system 10, which can be expensive and bulky.

Another traditional solution includes utilizing a soft start controller, which the power supply 26 can use to implement a voltage ramp profile to energize the brake coil 24. However, for a typical ramp of 0 to 24 volts with a slope of IV/500 mS, a typical latency time can exceed approximately 12 seconds.

Moreover, none of the traditional solutions appear to control noise generated during brake and clutch operations within medical imaging equipment, wherein applicable systems and methods substantially decrease metal-to-metal contact between stationary members 20, rotary members 32, and base plates 34, or work independently of supply voltage variations, or provide for silent and smooth brake and clutch operations over wide ranges of power applied from power supplies 26.

And similar to the described brake and brake operations, similar operational characteristics also occur with clutch and clutch operations and the like.

### SUMMARY OF INVENTION

In one embodiment, a noise control method for a brake or clutch comprises coupling a stationary member to a rotary member of a brake or clutch, wherein attraction or repulsion between the stationary member and rotary member results from an apply or release operation of the brake or clutch, and applying a voltage profile to at least one of the stationary member or rotary member during operation of the brake or clutch in order to move the stationary member and rotating member relative to one another at one or more desired speeds in order to decrease noise during operation of the brake or clutch.

In another embodiment, a noise control method for a brake or clutch comprises generating a voltage profile having at least one step profile and at least one ramp profile; and applying the voltage profile to at least one of a stationary member or rotary member of a brake or clutch in order to decrease noise during operation of the brake or clutch.

In yet another embodiment, a noise controller for a brake or clutch comprises a stationary member coupled to a rotary member of a brake or clutch, wherein attraction or repulsion between the stationary member and rotary member results from an apply or release operation of the brake or clutch, and a voltage generator operatively coupled to at least one of the stationary member or rotary member, wherein the voltage generator generates a voltage profile comprising at least one step profile and at least one ramp profile that are selectively applied to at least one of the stationary member and rotating member in order to reduce noise during operation of the brake or clutch.

And in yet another embodiment, medical equipment comprises a stationary member coupled to a rotary member of a brake or clutch of the medical equipment, wherein attraction or repulsion between the stationary member and rotary member results from an apply or release operation of the brake or clutch, and a voltage generator operatively coupled to at least one of the stationary member or rotary member, wherein the voltage generator generates a voltage profile comprising at least one step profile and at least one ramp profile that are selectively applied to at least one of the stationary member and rotating member in order to reduce noise during operation of the brake or clutch.

### BRIEF DESCRIPTION OF SEVERAL VIEWS OF THE DRAWINGS

A clear conception of the advantages and features constituting inventive arrangements, and of various construction and operational aspects of typical mechanisms provided by such arrangements, are readily apparent by referring to the following illustrative, exemplary, representative, and non-limiting figures, which form an integral part of this specification, in which like numerals generally designate the same elements in the several views, and in which:

FIG. 1 depicts a high-level block diagram of an electromechanical brake or brake system;

FIG. 2 depicts a high-level block implementation diagram of systems and methods for reducing or eliminating audible noise in brakes and clutches during brake and clutch operations; and

FIG. 3 depicts a voltage profile for controlling a brake or clutch.

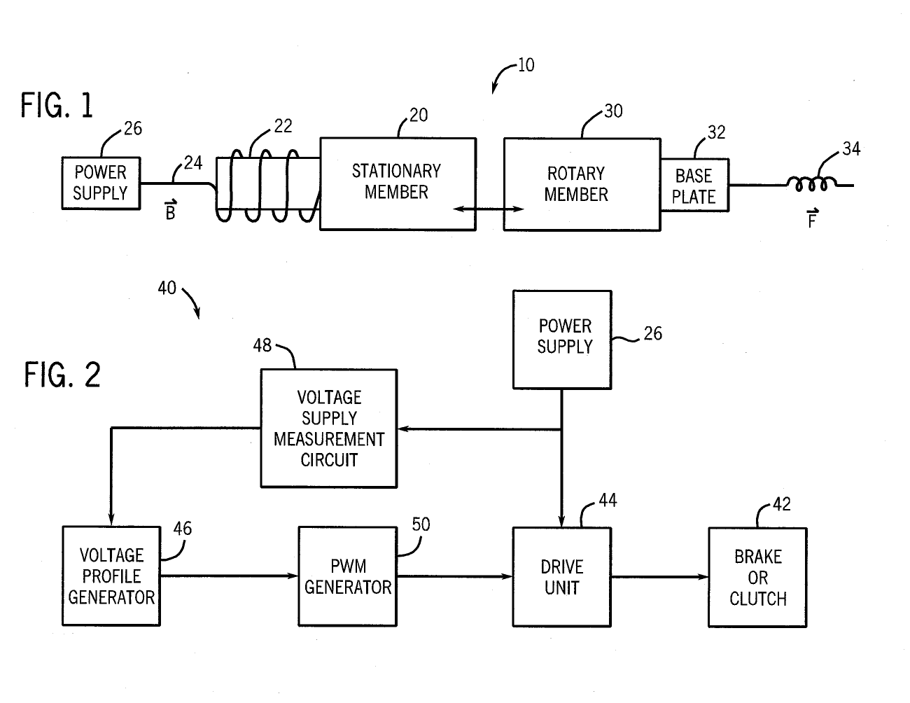

### DETAILED DESCRIPTION OF PREFERRED EMBODIMENTS

Various embodiments of the inventive arrangements provide systems and methods for reducing or eliminating audible noise in brakes and clutches during brake and clutch operations. However, the inventive arrangements are not limited in this regard, and they may also be implemented in connection with other applications as well.

Referring now to FIG. 2, a voltage controller 40 for a brake or clutch 42 is depicted. More specifically, the voltage controller 40 includes a power supply 26 that is operatively connected to i) a drive unit 44, and ii) a voltage profile generator 46 through a voltage supply measurement circuit 48.

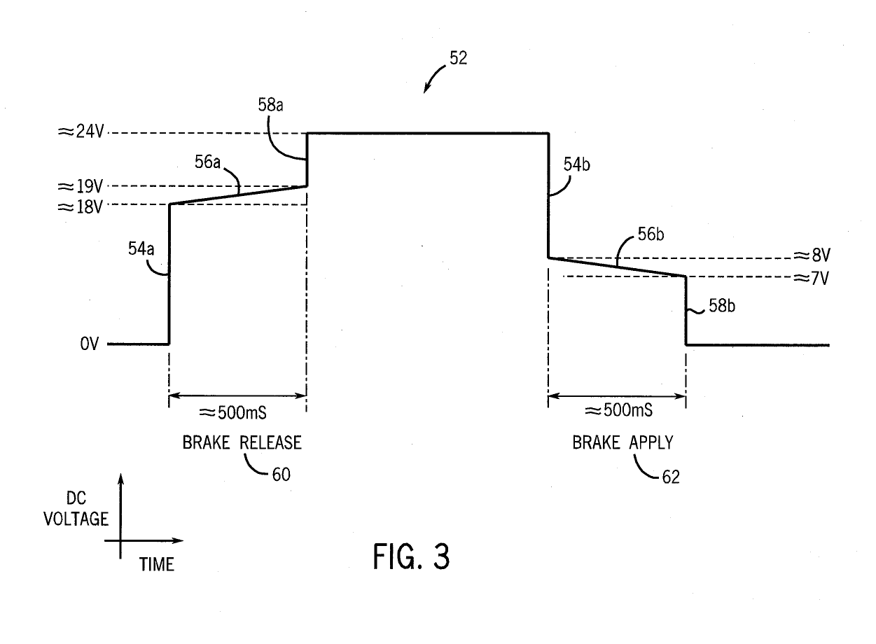

Preferably, the voltage profile generator 46 is also operatively coupled to a Pulse Width Modulation (“PWM”) generator 50, which drives the brake or clutch 42 through the drive unit 44, which is operatively coupled between the PWM generator 50 and brake or clutch 42. Alternatively, the voltage profile generator 46 may also include a servo controller (not shown), perhaps instead of the PWM generator 50, for driving the brake or clutch 42 through the drive unit 44. Regardless, the drive unit 44 preferably drives the brake or clutch 42 according to a gradually varying voltage profile, such as that depicted in FIG. 3.

Preferably, the voltage profile generator 46 generates a dc voltage pulse of desired magnitude for a desired period of time. The PWM generator 50 is, in turn, configured for modulating the dc voltage pulse from the voltage profile generator 46, and, in turn, generating the varying voltage profile depicted in FIG. 3, ultimately supplying desired supply voltage signals that drive the brake or clutch 42 through the drive unit 44. And preferably, the voltage supply measurement circuit 48 measures the voltage from the power supply 26 that is ultimately supplied to the brake or clutch 42 through the drive unit 44, and the drive unit 44 preferably includes (although not shown) i) a switching device, such as a MOSFET, relay, transistor, etc., and ii) a switching driver for driving the brake or clutch 42 as desired.

As previously described, release and apply operations of the brake or clutch 42 cause the magnetic attraction or repulsion of the stationary member 20 and rotary member 30. As will be further described, the voltage of a gradually varying profile, according to the inventive arrangements, reduces or substantially reduces the magnetic attraction and repulsion speed between the stationary member 20 and rotary member 30. This, in turn, substantially decreases the metal-to-metal contact, and noise, between the stationary member 20, rotary member 30, and base plate 32. Since the energy of the rotating member 30 can be substantially reduced and controlled, noise generated during the attraction and repulsion of the stationary member 20, rotary member 30, and base plate 32 can also be reduced or substantially reduced.

Referring now to FIG. 3, a voltage profile 52 for controlling the brake or clutch 42 is depicted. More specifically, time is plotted on an x-axis against a DC voltage plotted on a y-axis, yielding a desired voltage profile 52 for energizing the brake or clutch 42. Alternatively, another current profile 52′ (not shown) could also be readily substituted for the voltage profile 52 with equal or substantially equal effect. Regardless, the voltage profile 52 is depicted for convenience, ultimately controlling operation of the brake or clutch 42.

More specifically, FIG. 3 depicts a preferred voltage profile 52 for time-varying the voltage supplied to the brake or clutch 42. Accordingly, the voltage profile 52, as depicted, comprises at least one step profile 54,58 and at least one ramp profile 56 for both a brake release operation 60 and a brake apply operation 62, both of which can reduce or substantially reduce noise during operation of the brake or clutch 42, as will now be illustrated by the following example:

In the illustrative, exemplary, representative, and non-limiting example shown in FIG. 3, during a brake release operation 60, for example, for a dc pulse of 0-24 volts, a first step profile 54a is generated from 0 volts up to approximately 18 volts upstream. Then, a ramp-up (or first ramp) profile 56a is initiated at the approximate 18 volts and terminated at approximately 19 volts. And finally, a second step profile 58a is then applied from the approximate 19 volts up to approximately 24 volts upstream. Likewise, during a brake apply operation 62, for example, again for the same dc pulse of 0-24 volts, a first step profile 54b is generated from 24 volts down to approximately 8 volts downstream. Then, a ramp-down (or second ramp) profile 56b is initiated at the approximate 8 volts and terminated at approximately 7 volts. And finally, a second step profile 58b is then applied from the approximate 7 volts down to 0 volts downstream.

It should be noted that the magnitudes of the dc voltages and the duration of the ramp 54, 58 and step profiles 56 can be appropriately varied depending upon the force required or desired to operate the brake or clutch 42. For example, in the example shown in FIG. 3, the duration of each of the ramp profiles 56 is about 500 mS.

Accordingly, by implementing varying voltage profiles 52 according to the inventive arrangements via the voltage controller 40, noise during operation of the brake or clutch 42 can be reduced or substantially reduced. In addition, decreasing the metal-to-metal contact between the stationary member 20, rotary member 30, and base plate 32 can also reduce or substantially reduce the wear-and-tear on these components, thereby advantageously extending the life of the brake or clutch 42.

Regardless, in a preferred embodiment, the voltage supplied to the drive unit 44 is measured continuously, and the start and stop of the ramp profiles 56 within a specified voltage range can be adjusted in response to variations in supply voltages. Thus, noise generated during operation of the brake or clutch 42 can be significantly controlled even in the face of widely fluctuating supply voltages from a given power source 26.

It should be readily apparent that this specification describes exemplary, representative, and non-limiting embodiments of the inventive arrangements. Accordingly, the scope of the inventive arrangements are not limited to any of these embodiments. Rather, various details and features of the embodiments were disclosed as required. Thus, many changes and modifications-as readily apparent to those skilled in the art—are within the scope of the inventive arrangements without departing from the spirit hereof, and the inventive arrangements include the same. Accordingly, to apprise the public of the scope and spirit of the inventive arrangements, the following claims are made:

What is claimed is:

1. A noise control method for a brake or clutch, comprising:
coupling a stationary member to a rotary member of a brake or clutch, wherein attraction or repulsion between the stationary member and rotary member results from an apply or release operation of the brake or clutch, and
applying a voltage profile to at least one of the stationary member or rotary member during operation of the brake or clutch in order to move the stationary member or rotating member relative to one another at one or more desired speeds in order to decrease noise during operation of the brake or clutch.

2. The method of claim 1, wherein the voltage profile comprises at least one step profile and at least one ramp profile.

3. The method of claim 1, wherein the voltage profile comprises at least two step profiles and at least one ramp profile.

4. The method of claim 1, wherein the voltage profile comprises at least one ramp profile intermediate at least two step profiles.

5. The method of claim 1, wherein the voltage profile comprises one or more dc voltage pulses.

6. The method of claim 1, further comprising adjusting the voltage profile in response to one or more variations in supply voltage.

7. The method of claim 1, wherein the brake or clutch is adapted for use in medical imaging equipment.

8. The method of claim 1, wherein the stationary member and rotary member are constructed from at least a portion of metallic material and wherein applying the voltage profile reduces metal-to-metal contact during operation of the brake or clutch.

9. A noise control method for a brake or clutch, comprising:
generating a voltage profile having at least one step profile and at least one ramp profile; and
applying the voltage profile to at least one of a stationary member or rotary member of a brake or clutch in order to decrease noise during operation of the brake or clutch.

10. The method of claim 9, wherein the voltage profile comprises at least two step profiles.

11. The method of claim 9, wherein at least one ramp profile is intermediate at least two step profiles.

12. The method of claim 9, wherein the voltage profile comprises one or more dc voltage pulses.

13. The method of claim 9, further comprising adjusting the voltage profile in response to one or more variations in supply voltage.

14. The method of claim 9, wherein the brake or clutch is adapted for use in medical imaging equipment.

15. A noise controller for a brake or clutch, comprising:
a stationary member coupled to a rotary member of a brake or clutch, wherein attraction or repulsion between the stationary member and rotary member results from an apply or release operation of the brake or clutch, and
a voltage generator operatively coupled to at least one of the stationary member or rotary member, wherein the voltage generator generates a voltage profile comprising at least one step profile and at least one ramp profile that are selectively applied to at least one of the stationary member and rotating member in order to reduce noise during operation of the brake or clutch.

16. The noise controller of claim 15, further comprising:
a drive unit coupling the voltage generator to at least one of the stationary member and rotary member.

17. The noise controller of claim 15, wherein the brake or clutch is adapted for use in medical imaging equipment.

18. Medical imaging equipment, comprising:
a stationary member coupled to a rotary member of a brake or clutch of the medical imaging equipment, wherein attraction or repulsion between the stationary member and rotary member results from an apply or release operation of the brake or clutch, and
a voltage generator operatively coupled to at least one of the stationary member or rotary member, wherein the voltage generator generates a voltage profile comprising at least one step profile and at least one ramp profile that are selectively applied to at least one of the stationary member and rotating member in order to reduce noise during operation of the brake or clutch.

19. The medical imaging equipment of claim 18, further comprising:
a drive unit coupling the voltage generator to at least one of the stationary member and rotary member.
